(19) United States
(12) Patent Application Publication
(10) Pub. No.: US 2026/0050368 A1
(43) Pub. Date: Feb. 19, 2026

(54) INTERFACE INTERACTION METHOD, APPARATUS, DEVICE AND STORAGE MEDIUM

(71) Applicants: Beijing Zitiao Network Technology Co., Ltd., Beijing (CN); LEMON INC., Grand Cayman (KY)

(72) Inventors: Jiahui Yang, Beijing (CN); Jiayi Xu, Beijing (CN); Wei Xu, Los Angeles, CA (US)

(21) Appl. No.: 19/302,786

(22) Filed: Aug. 18, 2025

(30) Foreign Application Priority Data
Aug. 19, 2024 (WO) PCT/CN2024/113217

(51) Int. Cl. G06F 3/04842; G06F 3/04817; G06F 3/04883; G06Q 50/00; H04L 51/04

(52) U.S. Cl. CPC G06F 3/04842; G06F 3/04817; G06F 3/04883; G06Q 50/01; H04L 51/04

(57) ABSTRACT

Embodiments of the disclosure relate to an interface interaction method, apparatus, device and storage medium. A method includes: presenting a viewing interface of an information stream associated with a current user; and based on a selection of a target user for a target interaction item associated with the current user, presenting an interaction component in the viewing interface, the interaction component presenting identification information of the target user and first content generated based on the target interaction item. In this way, the embodiments of the disclosure are capable of presenting an interaction message in the interface of the information stream.

### CROSS-REFERENCE

The present application claims priority to PCT Application No. PCT/CN2024/113217, filed on Aug. 19, 2024, and entitled “INTERFACE INTERACTION METHOD, APPARATUS, DEVICE AND STORAGE MEDIUM”, the entirety of which is incorporated herein by reference.

### FIELD

Example embodiments of the present disclosure generally relate to the field of computers, and in particular, to an interface interaction method, apparatus, device, and computer-readable storage medium.

### BACKGROUND

In recent years, with the development of the Internet, more and more users perform activities on network platforms. For example, users may send or view interaction messages on network platforms. However, existing network platforms present the interaction messages in a way that cannot meet user requirements.

### SUMMARY

In a first aspect of the present disclosure, an interface interaction method is provided. The method comprises: presenting a viewing interface of an information stream associated with a current user; and presenting an interaction component in the viewing interface based on a selection of a target user for a target interaction item associated with the current user, the interaction component presenting identification information of the target user and first content generated based on the target interaction item.

In a second aspect of the present disclosure, an apparatus for interface interaction is provided. The device comprises a presenting module configured to present a viewing interface of an information stream associated with a current user; and a processing module configured to present an interaction component in the viewing interface based on selection of a target user for a target interaction item associated with the current user, the interaction component presenting identification information of the target user and first content generated based on the target interaction item.

In a third aspect of the present disclosure, an electronic device is provided. The device comprises at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, being executable by the processor to implement the method of the first aspect.

It would be appreciated that the content described in this content section is not intended to limit the key features or important features of the embodiments of the present disclosure, nor is it intended to limit the scope of the present disclosure. Other features of the present disclosure will become readily appreciated from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment capable of implementing some embodiments of the present disclosure;

FIGS. 2A to 2F illustrate example interfaces in accordance with some embodiments of the present disclosure;

FIGS. 3A to 3D illustrate example interfaces according to further embodiments of the present disclosure;

FIG. 4 illustrates a flowchart of an example process of message interaction according to some embodiments of the present disclosure;

FIG. 5 illustrates a schematic structural block diagram of an example apparatus for message interaction according to some embodiments of the present disclosure; and

FIG. 6 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it would be appreciated that the present disclosure may be implemented in various forms, and should not be interpreted as limited to the embodiments described in this specification. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

It should be noted that the headline of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The term “first,” “second,” and similar terms may refer to different or identical objects. Other explicit and implicit definitions may also be included below.

Embodiments of the present disclosure may relate to user data, acquisition and/or use of data, and the like. These aspects shall comply with the requirements of corresponding laws, regulations and relevant provisions. In the embodiments of the present disclosure, the collection, acquisition, processing, manufacturing, forwarding, use of all data and the like are carried out with user's knowledge and consent. Accordingly, in the implementation of the embodiments of the present disclosure, users should be informed of the type, the scope of use, the use scenario, etc., of the involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract, etc.) and will be performed only within a specified or agreed scope. If users decline the processing of personal information beyond what is essential for basic functionalities, their utilization of these basic features remains uninterrupted.

As briefly mentioned above, as the Internet develops, more and more users perform activities on network platforms. For example, users may send or view interaction messages on the network platforms. However, the existing network platforms present the interaction messages in the way that cannot meet the user requirements.

Embodiments of the present disclosure provide a solution for interface interaction. According to the solution, a viewing interface of an information stream associated with a current user may be presented; and based on a selection of a target user for a target interaction item associated with the current user, an interaction component is presented in the viewing interface, and the interaction component presents identification information of the target user and first content generated based on the target interaction item.

In this way, the embodiments of the present disclosure can present the interaction component in the viewing interface of the information stream to present, through the interaction component, the identification information of the target user and the interaction operation associated with the target user. In this way, the embodiments of the present disclosure can present the interaction message and related content from the target user in the viewing interface of the information stream, thereby meeting the user requirements.

Various example implementations of this solution are described in detail below in conjunction with the accompanying drawings.

### Example Environment

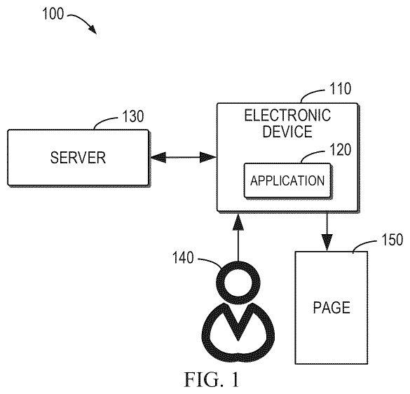

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a social application, or other suitable application. A user 140 may interact with the application 120 via the electronic device 110 and/or its attachment device.

In the environment 100 of FIG. 1, if the application 120 is active, the electronic device 110 may present a page 150 for supporting interface interaction via the application 120.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may comprise, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be appreciated that the structures and functions of the various elements in the environment 100 are described for exemplary purposes only and do not imply any limitation to the scope of the present disclosure.

Some example embodiments of the present disclosure will be described below with continued reference to the accompanying drawings.

### Push and Interaction of Interaction Messages

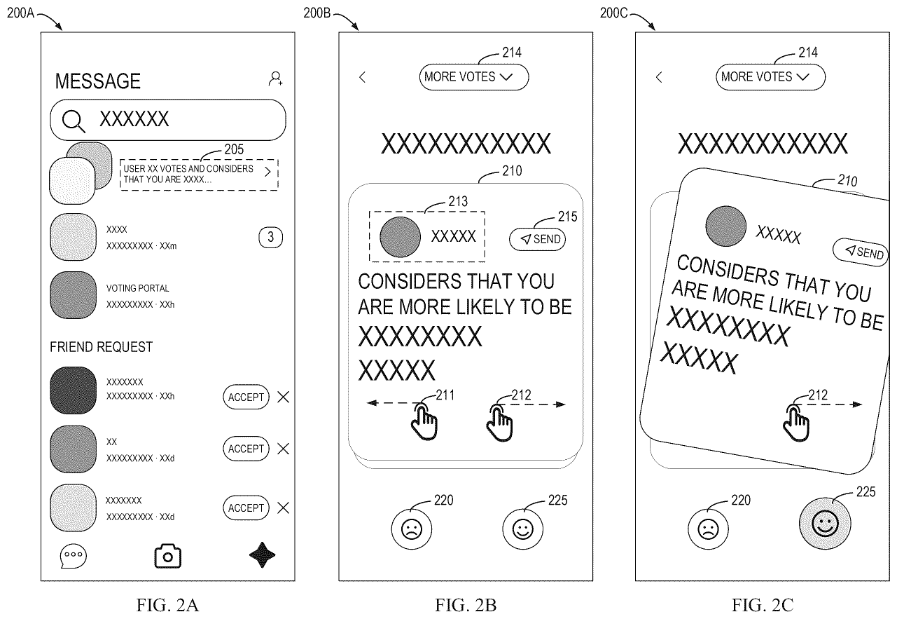

FIGS. 2A to 2F illustrate example interfaces 200A to 200F, in accordance with some embodiments of the present disclosure. The interface 200A to the interface 200F may be provided, for example, by the electronic device 110 shown in FIG. 1.

In some embodiments, as shown in FIG. 2A, the electronic device 110 may present the message interface 200A. As an example, the electronic device 110 may present message content received by the current user (e.g., a received message from other users or a friend request from other users, etc.) in the message interface 200A.

In some embodiments, with continued reference to FIG. 2A, the electronic device 110 may receive an interaction message for the current user. The electronic device 110 may present an interaction message portal 205 in the message interface 200A. As an example, the interaction message portal 205 may present at least one interaction message received by the current user. As an example, the at least one interaction message may include an interaction message generated based on an interaction operation of the plurality of users. As an example, the at least one interaction message may include an interaction message from a target user.

In some embodiments, the process of generating the interaction message from the target user may comprise: generating, by a client associated with the target user, an interaction message associated with a target interaction item based on a selection of the target user for the target interaction item associated with the current user. Further, the electronic device 110 may receive the interaction message associated with the target interaction item sent by the client associated with the target user.

As an example, the client associated with the target user may determine the target interaction item selected by the target user based on an interaction operation of the target user. As an example, the client associated with the target user may determine the target interaction item selected by the target user based on a voting operation of the target user on a voting component (e.g., a selection of at least one of a plurality of voting options). As an example, the voting component may include descriptive content (e.g., who do you think is the most XXX?). The plurality of voting options may include a plurality of options (e.g., user A, user B, user C, user D, etc.). The target interaction item may include, for example, the user C associated with the current user.

As an example, the electronic device 110 may present in the message interface 200A image content associated with at least one interaction message (e.g., a partial user avatar associated with the at least one interaction message).

In some embodiments, as shown in FIG. 2B, the electronic device 100 may present an interaction component 210 in the viewing interface 200B.

In some embodiments, with continued reference to FIG. 2B, the electronic device 110 may present the interaction component 210 in the viewing interface 200B based on a selection of the target user for the target interaction item associated with the current user.

As an example, a client associated with the target user may trigger the electronic device 110 to present the interaction component 210 in the viewing interface 200B in response to receiving a selection of the target user for the target interaction item associated with the current user.

In some embodiments, the electronic device 110 may present the viewing interface 200B associated with the current user in response to receiving a first predetermined operation of the current user on the interaction message. As an example, as shown in FIG. 2A, the electronic device 110 may present the viewing interface 200B associated with the current user in response to receiving a trigger (e.g., a click operation) of the current user on the interaction message portal 205.

In some embodiments, the viewing interface 200B may be a viewing interface B of the information stream associated with the current user.

In some embodiments, with continued reference to FIG. 2B, the electronic device 110 may switch the viewing interface 200B to presenting media content in the information stream in response to a fifth predetermined operation (e.g., a sliding operation) received in the viewing interface 200B.

In some cases, the information stream is also referred to as a Feed stream, which can be associated with multiple pieces of media content (e.g., multiple content items), and supporting the first user to switch to playing other media content in the information stream based on a predetermined operation (e.g., up and down) in the viewing interface 200B. As an example, the electronic device 110 may switch the viewing interface 200B to presenting, from the presentation interaction component 210, to the media content in the information stream in response to receiving a predetermined operation (e.g., up-down sliding or clicking operation, etc.) of the current user in the viewing interface 200B.

In some embodiments, the information stream may be associated with a variety of media content types. As an example, the media content type may include, but is not limited to, video content, text content, music content, etc.

In some embodiments, with continued reference to FIG. 2B, the electronic device 110 presents identification information 213 (e.g., a user avatar and/or a username, etc.) of the target user in the interaction component 210. In some embodiments, the electronic device 110 may further present, in the interaction component 210, the first content generated based on the target interaction item. As an example, the target interaction item may indicate description information for the current user (e.g., the friend that most conforms to description XXXX is XXXXX). The first content generated based on the target interaction item may comprise, for example, message content generated based on the description information of the current user (for example, XXX considers that you are more likely to be XXXX).

In some embodiments, the interaction component 210 may be associated with a first content set. As an example, the first content set may include a plurality of pieces of first content associated with a predetermined condition. The predetermined condition may comprise, for example, a predetermined theme (for example, a music theme, a life theme, etc.).

In some embodiments, with continued reference to FIG. 2B, the electronic device 110 may present the interaction component 210 in a target style in the viewing interface 200B. The target style may be determined based on a number of pieces of content to be presented in the first content set.

In some embodiments, with continued reference to FIG. 2B, the electronic device 110 may present, a plurality of component elements in the interaction component 210 in a stack, in response to the number of pieces of content to be presented being greater than a target threshold. As an example, if the first content set further comprises one or more pieces of content that are sequentially after the first content, the electronic device 110 may present a stacking style to indicate that the first content set further comprises one or more pieces of content to be presented.

In some embodiments, the target style may also indicate the number of one or more pieces of content to be presented. For example, the first content set may comprise a plurality of pieces of content to be presented, that is, the number of pieces of content to be presented is greater than one. Accordingly, the electronic device 110 may present a stack of multiple component elements. Taking FIG. 2B as an example, the electronic device 110 may present a stack of two component elements to indicate that the first content set includes two pieces of content to be presented.

In some embodiments, the number of component elements presented in the stack in the electronic device 110 may be the same as or different from the number of pieces of content to be presented. For example, when the first content set comprises more than a predetermined number (e.g., three) of pieces of content to be presented, the electronic device 110 may, for example, always present a stack of three component elements to reduce the complexity of the interaction component 210.

In some embodiments, with continued reference to FIG. 2B, the electronic device 110 may switch the interaction component 210 to presenting second content in the first content set in response to a second predetermined operation for the interaction component 210. As an example, the second predetermined operation may comprise a sliding operation. The electronic device 110 may switch the interaction component 210 to presenting the second content in the first content set in response to the sliding operation on the interaction component 210. As an example, the second content may be determined based on a sliding direction of the sliding operation.

In some embodiments, as shown in FIG. 2C, the electronic device 110 may present, in response to receiving a sliding operation 212, an animation process of switching the interaction component 210 to presenting the second content (e.g., rotation and/or movement of the interaction component 210, etc.) until the interaction component 210 fully presents the second content.

In some embodiments, with continued reference to FIG. 2B, the electronic device 110 may send a message determined based on a third predetermined operation to the target user in a conversation between the current user and the target user in response to receiving the third predetermined operation in the viewing interface.

In some embodiments, the third predetermined operation may comprise a sliding operation for the interaction component.

As an example, with continued reference to FIG. 2B, the electronic device 110 may receive a sliding operation 212 of the current user. In some embodiments, such the sliding operation 212 may indicate a target direction. For example, the sliding operation 212 may comprise the sliding operation in the target direction, for example, a right-sliding operation. As an example, the electronic device 110 may send a message (e.g., “happy”) corresponding to the sliding operation 212 to the conversation between the current user and the target user.

As an example, with continued reference to FIG. 2B, the electronic device 110 may receive a sliding operation 211 of the current user. In some embodiments, such the sliding operation 211 may indicate a target direction. For example, the sliding operation 211 may include a sliding operation in a target direction, for example, a left-sliding operation. As an example, the electronic device 110 may send a message (e.g., “sad”) corresponding to the operation 211 to a conversation between the current user and the target user.

In some embodiments, with continued reference to FIG. 2B, the third predetermined operation may comprise a selection of an indication element in the viewing interface 200B, and the indication element corresponds to predetermined feedback for the first content.

In some embodiments, with continued reference to FIG. 2B, the electronic device 110 may provide a plurality of indication elements in the viewing interface. As an example, the plurality of indication elements may correspond to a plurality of pieces of predetermined feedback. As an example, the predetermined feedback may indicate feedback of the current user to the first content. The electronic device 110 may generate the message content based on the predetermined feedback. As an example, the plurality of indication elements may include a first indication element 220 and a second indication element 225. As an example, the first indication element 220 may indicate first feedback of the plurality of pieces of predetermined feedback. The second indication element 225 may indicate second feedback of the plurality of pieces of predetermined feedback.

In some embodiments, the first indication element 220 may be associated with the sliding operation 211 in the first direction. Further, in response to receiving the sliding operation 211, the electronic device 110 may send the message content generated based on the first feedback to the conversation between the current user and the target user.

In some embodiments, the second indication element 225 may be associated with the sliding operation 212 in the second direction. Further, in response to receiving the sliding operation 212, the electronic device 110 may send the message content generated based on the second feedback to the conversation between the current user and the target user.

In some embodiments, as shown in FIG. 2C, the electronic device 110 may present the second indication element 225 differently in the viewing interface 200C (e.g., adjust the background color and/or size of the second indication element 225) in response to receiving the sliding operation 212 in the viewing interface 200C.

In some embodiments, as shown in FIG. 2D, the electronic device 110 may present, in the viewing interface 200D, an animation effect associated with the second indication element (for example, a process in which a plurality of different smiley face images emerge from the second indication element 225 and gradually disappear).

In some embodiments, the electronic device 110 may further send the message content generated based on the first feedback or the second feedback to the conversation between the current user and the target user in response to receiving a selection (e.g., a click operation) of the current user for the first indication element 220 or the second indication element 225.

In some embodiments, with continued reference to FIG. 2B, the third predetermined operation may comprise a selection of a message portal in the viewing interface 200B. As an example, the electronic device 110 may provide a message portal 215 in the viewing interface 200B. Further, the electronic device 110 may send a message (for example, a text message, a voice message, an image message, etc.) obtained via the message portal 215 to the conversation between the current user and the target user.

In some embodiments, with continued reference to FIG. 2D, the interaction component 210 is a first interaction component. The electronic device 110 may provide a filtering control 214 in the viewing interface 200D. The electronic device 110 may present a second interaction component in the viewing interface 200D based on a target condition determined via the filtering control 214. The second interaction component is associated with a second content set that matches the target condition.

As an example, the electronic device 110 may present a plurality of predetermined conditions in response to a trigger on the filtering control 214. The plurality of predetermined conditions may comprise, for example, a plurality of predetermined topics (for example, a music topic, a life topic, etc.), a plurality of friend relationships (for example, a close friend, a stranger, etc.). Further, the electronic device 110 may present, based on a selection of the current user for a target condition of the plurality of predetermined conditions, the second interaction component associated with the target condition.

In some embodiments, as shown in FIG. 2E, the electronic device 110 may provide an adding portal 230 in the interaction component 210 in response to receiving a fourth predetermined operation in the viewing interface 200E. The adding portal 230 is configured to trigger adjustment of the interaction relationship between the current user and the target user. As an example, the interaction relationship may comprise a friend relationship.

As an example, with continued reference to FIG. 2E, the electronic device 110 may present the adding portal 230 in the interaction component 210 in response to receiving a request of the current user to send a message to the target user (e.g., the aforementioned third predetermined operation). As an example, the electronic device 110 may present the adding portal 230 in the interaction component 210 in response to receiving the request of the current user to send a message to the target user, and the current user and the target user do not satisfy the interaction relationship. Further, the electronic device 110 may send a request of establishing an interaction relationship (for example, adding a friend) to the target user in response to receiving a trigger (for example, a click operation) of the current user for the adding portal 230.

In some embodiments, with continued reference to FIG. 2D, the electronic device 110 may present a selection control (not shown in the FIG. 2D) in the viewing interface 200D in response to the current user's request. Further, the electronic device 110 may receive a selection of the current user for a second user via the selection control. As an example, the electronic device 110 may present a plurality of user options (e.g., a plurality of user options associated with the current user) in response to a trigger (e.g., a click operation) of the current user for the selection control. Further, the electronic device 110 may receive a selection of the current user for a target user option of the plurality of user options, and determine the second user.

In some embodiments, the electronic device 110 may receive a selection of the second user by the current user. Further, the electronic device 110 may trigger, in response to a predetermined condition associated with the second user being satisfied, a client associated with the second user to present at least one interaction item associated with the current user to the second user. As an example, the electronic device 110 may invoke the server 130 to add a predetermined interaction item (for example, a voting option in a voting component) associated with the current user in the voting component associated with the second user. In this way, the probability that the current user appears in the voting options of the second user can be increased, and the interaction efficiency and the interaction amusement between the current user and the second user are further improved.

In some embodiments, the predetermined condition associated with the second user may include, for example, a degree of relationship between the current user and the first user (for example, a friend relationship, an interaction frequency, etc.) and/or a predetermined event associated with the interaction component (for example, an operation that needs to be performed by the current user, for example, an interaction operation).

In some embodiments, as shown in FIG. 2F, the electronic device 110 may present a message determined based on the second predetermined operation, in the conversation interface 200F of the current user and the target user. As an example, the electronic device 110 may also present an animation effect (e.g., an animation effect associated with the second indication element 225) corresponding to the message in the conversation interface 200F.

Based on the process described above, embodiments of the present disclosure can present an interaction component for the user in the viewing interface of the information stream. The interaction component may present content generated based on the interaction operation from other users. Moreover, the embodiment of the invention can support the user to switch the content presented by the viewing interface of the information stream and to quickly send a message to the target user based on various predetermined operations. Therefore, the embodiment of the present disclosure can meet the user requirement of message interaction, and improve the efficiency and the amusement of the user to view the message, reply to the message and user interaction.

### Interaction Message Generation Based on Interaction Component

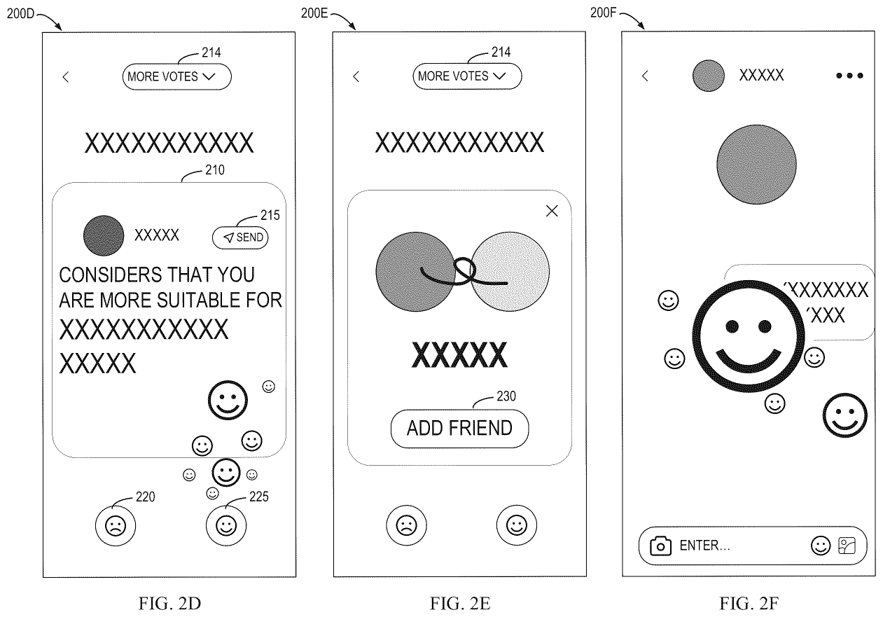

FIGS. 3A to 3D illustrate example interfaces 300A to 300D, in accordance with some embodiments of the present disclosure. The interface 300A to the interface 300D may be provided, for example, by the electronic device 110 shown in FIG. 1.

In some embodiments, as shown in FIG. 3A, electronic device 110 may present a message interface 300A. As an example, the electronic device 110 may present message content (e.g., a received message from other users or a friend request of other users, etc.) received by a first user in the message interface 300A. As an example, the first user herein may be the target user associated with the interaction message described above. The first user is the sender of the interaction message, and the current user described above is the receiver of the interaction message.

In some embodiments, with continued reference to FIG. 3A, the electronic device 110 may present an interaction portal 305 in the message interface 300A. As an example, the electronic device 110 may provide the interaction portal 305 (e.g., also referred to as a voting portal 305) in a message interface. Further, the electronic device 110 may present an interaction component associated with the interaction portal 305 in response to a trigger (e.g., a click operation) on the interaction portal 305. In some embodiments, the electronic device 110 may also present the interaction portal 305 in a viewing interface, for example.

In some embodiments, as shown in FIG. 3B, the electronic device 110 may present the viewing interface 300B. The electronic device 110 may present the interaction component 310 in the viewing interface 300B.

As an example, the electronic device 110 may present the interaction component 310 in the viewing interface 300B in response to a trigger for the interaction portal 305.

In some embodiments, with continued reference to FIG. 3B, the electronic device 110 may present an interaction component 310 in the viewing interface 300B of the information stream. In some cases, the information stream is also referred to as the Feed stream, which can be associated with multiple content items and support the first user to switch to playing other content items in the information stream based on a predetermined operation (e.g., an up-down sliding) in the viewing interface 300B. As an example, the electronic device 110 may present the interaction component 310 in the viewing interface 300B in response to receiving a predetermined operation (e.g., an up-down sliding or a click operation, etc.) of the first user in the viewing interface 300B.

In some embodiments, the information stream may be associated with a variety of content item types. As an example, the content item type may include, but is not limited to, a video content item, a graphic and text content item, a music content item, etc.

In some embodiments, with continued reference to FIG. 3B, the electronic device 110 may present the interaction component 310 in the viewing interface 300B of a first application. In this case, the interaction component 310 may be associated with the first application.

In some embodiments, with continued reference to FIG. 3B, the electronic device 110 presents a plurality of the interaction items 315 in the interaction component 310, for example, interaction item 315-1, and interaction item 315-2 (individually referred to as the interaction item 315 or collectively referred to as the interaction items 315).

In some embodiments, with continued reference to FIG. 3B, the electronic device 110 may also present the description content in the interaction component 310. As an example, the description content may be a voting problem (e.g., who do you think is most likely XXXX?) In some embodiments the plurality of interaction items 315 may correspond to a plurality of candidate users, for example, user A, user B, user C, and user D.

In some embodiments, with continued reference to FIG. 3B, the electronic device 110 may receive a selection of the first user for a target interaction item in the plurality of interaction items 315 to determine a target user corresponding to the target interaction item. As an example, the electronic device 110 may determine, in response to receiving a click operation of the first user on the target interaction item (for example, the interaction item 315-2) in the plurality of interaction items 315, that the target user corresponding to the target interaction item (for example, the interaction item 315-2) is the user B. In some embodiments, the selection of the first user for the target interaction item (e.g., interaction item 315-2) may be configured to indicate that (the first user believes that) the target user matches the description content.

In some embodiments, the plurality of candidate users are determined from a set of candidate users associated with the first user. As an example, the set of candidate users associated with the first user is provided by the first user. As an example, the set of candidate users may include a plurality of candidate users associated with the first user.

In some embodiments, with continued reference to FIG. 3B, the electronic device 110 may present, in the interaction component 310, an indication element corresponding to at least one of the plurality of interaction items. The indication element may be used to indicates a source type of at least one candidate user corresponding to the at least one interaction item. As an example, the indication element may comprise, for example, an application identifier (or referred to as an icon) to indicate that the source type of the at least one candidate user corresponding to the at least one interaction item is an application associated with the application identifier.

As an example, as shown in FIG. 3B, the electronic device 110 may present an indication element 316-1 associated with the interaction item 315-1 in the interaction component 310. The indication element 316-1 may be configured to indicate the source type of the user A corresponding to the interaction item 315-1. As an example, the user A may come from a second application different from the first application. For example, the electronic device 110 may present the indication element 316-2 associated with the interaction item 315-2 in the interaction component 310. The indication element 316-2 may be configured to indicate the source type of the user B corresponding to the interaction item 315-2. As an example, the user B may be determined based on communication information associated with the first user. As an example, if there is no indication element associated with the interaction item 315-3, it may indicate that the user C corresponding to the interaction item 315-3 is from the first application. As an example, the user C and the first user are associated with the same application (e.g., the first application).

In some embodiments, with continued reference to FIG. 3B, the plurality of interaction items may comprise identification information of the plurality of candidate users. The identification information may comprise an image identification and/or a text identification. As an example, the image identification may be, for example, an avatar of the candidate user. The text identification may be, for example, a nickname or name of the candidate user, a note name set by the first user, or the like. As an example, as shown in FIG. 3B, the interaction item 315-1 may comprise an image identification 317-1 and a text identification (for example, “user A”).

In some embodiments, with continued reference to FIG. 3B, the electronic device 110 may trigger to send, in a target transmission mode, the interaction message to the target corresponding to the target interaction item based on the selection of the first user for the target interaction item in the plurality of interaction items 315. The target transmission mode is determined from a plurality of predetermined transmission modes based on source information of the target user. In some embodiments, the interaction message may indicate an interaction between the first user and the interaction component. For example, the interaction message may indicate a selection operation of the first user on the interaction component (for example, “the first user considers you in the XX application is . . . ”), and in this case, the interaction message may indicate the selection operation of the first user on the target interaction item, but does not comprise the description content (for example, the voting problem) associated with the interaction component. In this way, the target user receiving the interaction message needs to further operate (click, or further view, etc.) on the interaction message to obtain the description content associated with the interaction component, which can increase the interactivity and amusement between users.

In some embodiments, the set of candidate users associated with the first user corresponds to a plurality of predetermined transmission modes.

In some embodiments, the plurality of predetermined transmission modes may comprise a first transmission mode. The first transmission mode may be based on a first message service of the first application. As an example, as shown in FIG. 3B, the user C corresponding to the interaction item 315-3 and the first user may be associated with the first application, for example. The electronic device 110 may send the interaction message to the user C based on the first message service of the first application in response to receiving the selection of the first user for the interaction item 315-3.

In some embodiments, the plurality of predetermined transmission modes may comprise a second transmission mode. The second transmission mode may be based on a second message service of a second application. The second application is different from the first application. As an example, as shown in FIG. 3B, the user A corresponding to the interaction item 315-1 may be associated with, for example, the second application. The electronic device 110 may receive a selection of the first user for the interaction item 315-1, and send the interaction message to the user A in the second application based on the second message service of the second application.

In some embodiments, the plurality of predetermined transmission modes may comprise a third transmission mode. The third transmission mode may be based on Short Messaging Service (SMS). As an example, the user B corresponding to the interaction item 315-2 may be associated with a fourth application that transmits messages based on the short message service. The electronic device 110 may receive a selection of the first user for the interaction item 315-2, and send the interaction message to the user B based on the short message service.

In some embodiments, the electronic device 110 may provide a first access portal associated with the first application in the interaction message in response to the target transmission mode being the second transmission mode or the third transmission mode.

In some embodiments, the first access portal may be configured to direct to a viewing interface of the first application to present the selected target interaction item. As an example, the client of the user A or the user B may present, in response to a trigger (for example, a click operation) on the first access portal in the received interaction message, the viewing interface of the first application, and the viewing interface of the first application may present the target interaction item selected by the first user and the description content associated with the target interaction item.

In some embodiments, the first access portal may be configured to direct to a download interface for downloading the first application. As an example, the client of the user A or the user B may present the download interface of the first application in response to a trigger (e.g., a click operation) on the first access portal in the received interaction message. In this way, the user A or the user B may download the first application in its client based on the first access portal in the interaction message.

In some embodiments, with continued reference to FIG. 3B, the electronic device 110 may provide an update control 320 in the interaction component 310. Further, the electronic device 110 may update the description content and/or the plurality of the interaction items 315 in the interaction component 310 in response to receiving a trigger for the update control 320.

In some embodiments, as shown in FIG. 3C, the electronic device 110 may present the interaction component 310 updated via the trigger for the update control 320 in the viewing interface 300C. As an example, the plurality of interaction items 315 of the updated interaction component 310 may correspond to one candidate user (e.g., user E). The description content of the updated interaction component 310 may be, for example, “what do you think the user E is most likely to be”, and the plurality of interaction items 315 may correspond to a plurality of option contents (e.g., option 1, option 2, option 3, and option 4). Further, in response to receiving a selection of the target interaction item (for example, an interaction item associated with the option 2) in the plurality of interaction items, the electronic device 110 may send the interaction message corresponding to the target interaction item to the user E.

In some embodiments, as shown in FIG. 3D, the electronic device 110 may present the interaction component in a third application different from the first application. Further, in response to receiving a selection of the target interaction item, the electronic device 110 may present, in the third application, a second access portal 325 associated with the first application. As an example, the electronic device 110 may present, in response to a trigger (e.g., a click operation) on the second access portal 325, the viewing interface or the download interface of the first application. As an example, the viewing interface of the first application may present the target interaction item selected by the first user and the description content associated with the target interaction item.

Based on the processes described above, the embodiments of the present disclosure are capable of providing a user with a plurality of interaction items associated with a plurality of transmission modes. Further, the embodiments of the present disclosure may send an interaction message to a user corresponding to a target interaction item based on the transmission mode corresponding to the target interaction item selected by a first user. In this way, the embodiments of the present disclosure can provide multiple transmission modes for the first user to interact, meet the requirements of the first user to interact with users from different sources, and improve the interaction efficiency.

### Example Processes

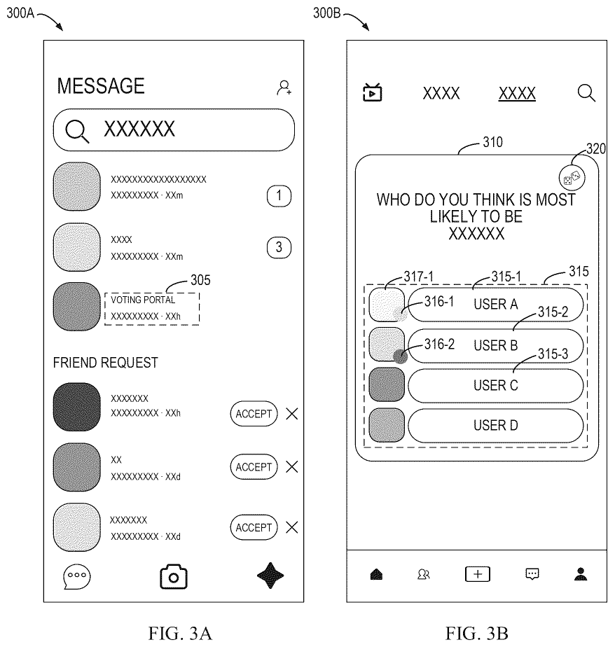

FIG. 4 illustrates a flowchart of an example process 400 of interface interaction in accordance with some embodiments of the present disclosure. The process 400 may be implemented at the electronic device 110. The process 400 is described below with reference to FIG. 1.

As shown, at block 410, the electronic device 110 presents a viewing interface of an information stream associated with a current user.

At block 420, the electronic device 110 presents an interaction component in the viewing interface based on a selection of a target user for a target interaction item associated with the current user, the interaction component presenting identification information of the target user and first content generated based on the target interaction item.

In some embodiments, presenting the viewing interface of the information stream associated with the current user comprises: receiving an interaction message associated with the target interaction item, the interaction message being sent in response to the selection of the target user for the target interaction item; and in response to a first predetermined operation for the interaction message, presenting the viewing interface of the information stream associated with the current user.

In some embodiments, the interaction component is associated with a first content set, and the process 400 further comprises switching the interaction component to presenting second content in the first content set in response to a second predetermined operation for the interaction component.

In some embodiments, presenting the interaction component in the viewing interface comprises: presenting the interaction component in a target style in the viewing interface, the target style being determined based on a number of pieces of content to be presented in the first content set.

In some embodiments, in response to the number of pieces of content to be presented being greater than a target threshold, the target style indicates that a plurality of component elements in the interaction component are to be presented in a stack.

In some embodiments, the interaction component is a first interaction component, and the process 400 further comprises: providing a filtering control in the viewing interface; and presenting a second interaction component in the viewing interface based on a target condition determined based on the filtering control, the second interaction component being associated with the second content set matching the target condition.

In some embodiments, the process 400 further includes: in response to a third predetermined operation received in the viewing interface, sending a message determined based on the third predetermined operation to the target user in a conversation between the current user and the target user.

In some embodiments, the third predetermined operation comprises at least one of the following: a sliding operation for the interaction component; a selection for an indication element in the viewing interface, the indication element corresponding to predetermined feedback for the first content; a selection for a message portal in the viewing interface.

In some embodiments, the process 400 further comprises: in response to a fourth predetermined operation received in the viewing interface, providing an adding portal in the interaction component, where the adding portal is configured to trigger adjustment of the interaction relationship between the current user and the target user.

In some embodiments, the process 400 further comprises: receiving a selection of the current user for a second user; and in response to a predetermined condition associated with the second user being satisfied, triggering a client associated with the second user to present at least one interaction item associated with the current user to the second user.

In some embodiments, the process 400 further comprises switching the viewing interface to presenting media content in the information stream in response to a fifth predetermined operation received in the viewing interface.

### Example Apparatus and Apparatus

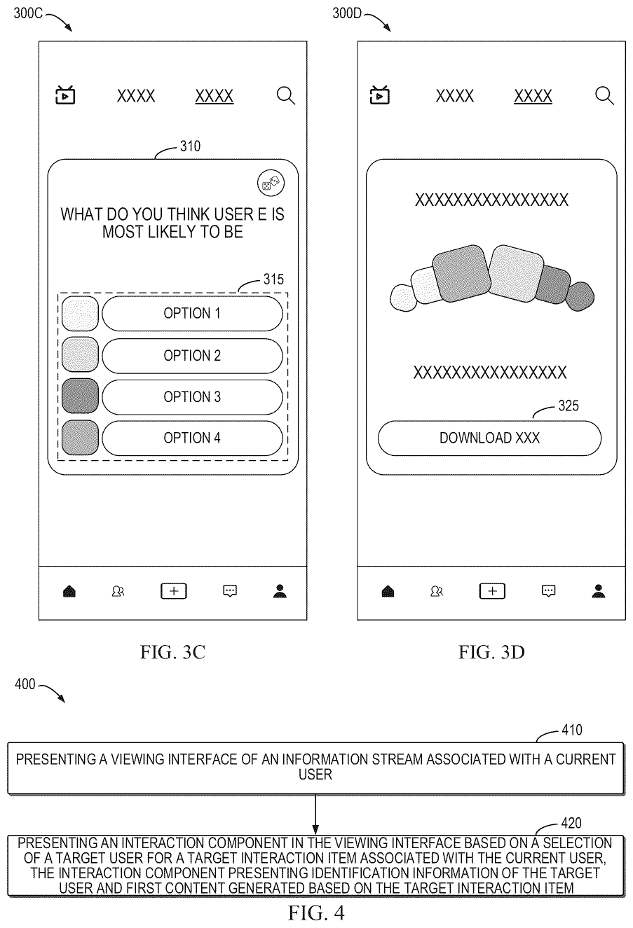

Embodiments of the present disclosure also provide a corresponding apparatus for implementing the above method or process. FIG. 5 shows a schematic structural block diagram of an example apparatus 500 for generating media content according to some embodiments of the present disclosure. The apparatus 500 may be implemented or comprised in an electronic device. The various modules/components in the apparatus 500 may be implemented by hardware, software, firmware, or any combination thereof.

As shown in FIG. 5, the apparatus 500 comprises a presenting module 510 configured to present a viewing interface of an information stream associated with a current user; and a processing module 520 configured to present an interaction component in the viewing interface, based on a selection of a target user for a target interaction item associated with the current user, the interaction component presenting identification information of the target user and first content generated based on the target interaction item.

In some embodiments, the presenting module 510 is further configured to: receive an interaction message associated with the target interaction item, the interaction message being sent in response to the selection of the target user for the target interaction item; and present the viewing interface of the information stream associated with the current user in response to a first predetermined operation for the interaction message.

In some embodiments, the interaction component is associated with a first content set, the apparatus 500 further comprises a switching module, and the switching module is configured to switch the interaction component to presenting second content in the first content set in response to a second predetermined operation for the interaction component.

In some embodiments, the processing module 520 is further configured to present the interaction component in a target style in the viewing interface, and the target style is determined based on a number of pieces of content to be presented in the first content set.

In some embodiments, in response to the number of pieces of content to be presented being greater than a target threshold, the target style indicates that a plurality of component elements in the interaction component are to be presented in a stack.

In some embodiments, the interaction component is a first interaction component, and the apparatus 500 further comprises a filtering module configured to: provide a filtering control in the viewing interface; and present a second interaction component in the viewing interface based on a target condition determined based on the filtering control, the second interaction component being associated with a second content set matching the target condition.

In some embodiments, the apparatus 500 further comprises a sending module configured to send a message determined based on a third predetermined operation to the target user in a conversation between the current user and the target user, in response to a third predetermined operation received in the viewing interface.

In some embodiments, the third predetermined operation comprises at least one of the following: a sliding operation for the interaction component; a selection for an indication element in the viewing interface, the indication element corresponding to predetermined feedback for the first content; a selection for a message portal in the viewing interface.

In some embodiments, the apparatus 500 further comprises an adding module configured to provide an adding portal in the interaction component in response to a fourth predetermined operation received in the viewing interface, wherein the adding portal is configured to trigger an adjustment of an interaction relationship between the current user and the target user.

In some embodiments, the apparatus 500 further comprises a trigger module configured to: receive a selection of the current user for a second user; and trigger a client associated with the second user to present at least one interaction item associated with the current user to the second user in response to a predetermined condition associated with the second user being satisfied.

In some embodiments, the apparatus 500 further comprises a viewing module configured to switch the viewing interface to presenting media content in the information stream, in response to a fifth predetermined operation received in the viewing interface.

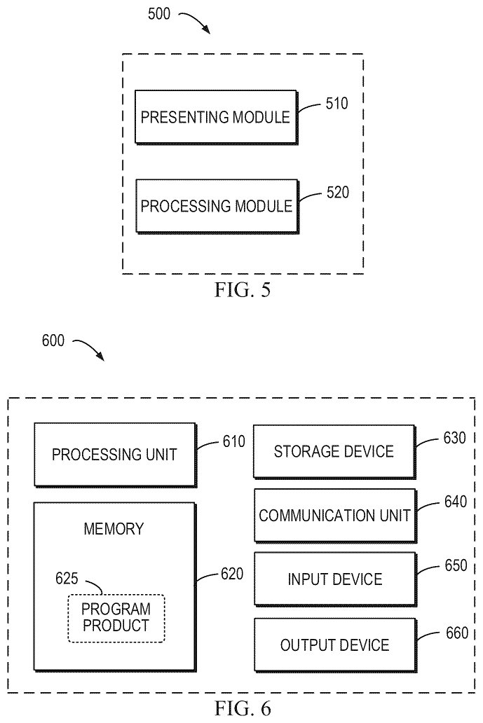

FIG. 6 illustrates a block diagram of an electronic device 600 in which one or more embodiments of the present disclosure may be implemented. It would be appreciated that the electronic device 600 illustrated in FIG. 6 is merely exemplary and should not constitute any limitation on the functionality and scope of the embodiments described herein. The electronic device 600 shown in FIG. 6 may be configured to be implement an electronic device.

As shown in FIG. 6, the electronic device 600 is in the form of a general-purpose electronic device. Components of the electronic device 600 may comprise, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve parallel processing capabilities of the electronic device 600.

The electronic device 600 typically comprises a plurality of computer storage media. Such media may be any available media accessible to the electronic device 600, comprising, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 630 may be a removable or non-removable medium and may comprise a machine-readable medium, such as a flash drive, magnetic disk, or any other medium, which may be capable of storing information and/or data and may be accessed within the electronic device 600.

The electronic device 600 may further comprise additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may comprise a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a present, a speaker, a printer, or the like. The electronic device 600 may also communicate with one or more external devices (not shown) through the communication unit 640 as needed, external devices such as storage devices, present devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, a computer-readable storage medium having computer-executable instructions stored thereon is provided, wherein the computer-executable instructions are executed by a processor to implement the method described above. According to example implementations of the present disclosure, a computer program product is further provided, the computer program product being tangibly stored on a non-transitory computer-readable medium and comprising computer-executable instructions, the computer-executable instructions is executed by a processor to implement the method described above.

Aspects of the present disclosure are described herein with reference to flowcharts and/or block diagrams of methods, apparatuses, devices, and computer program products implemented in accordance with the present disclosure. It would be appreciated that each block of the flowchart and/or block diagram, and combinations of blocks in the flowcharts and/or block diagrams, may be implemented by computer readable program instructions.

These computer-readable program instructions may be provided to the processing unit of a general purpose computer, special purpose computer, or other programmable data processing apparatus to produce a machine, such that the instructions, when executed by the processing unit of the computer or other programmable data processing apparatus, producing devices to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions comprises an article of manufacture comprising instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the one or more blocks in the flowchart and/or block diagram(s).

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that comprises one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above. The above description is exemplary, not exhaustive, and the present application is not limited to the disclosed implementations. Without departing from the scope and spirit of the various implementations, many modifications and changes are obvious to those skilled in the art. The terminology used herein has been chosen to best explain the principles of the respective implementations, the practical applications or improvements to technology in the marketplace, or to enable others of ordinary skill in the art to understand the various implementations disclosed herein.

1. A method for interface interaction, comprising:
presenting a viewing interface of an information stream associated with a current user; and
presenting an interaction component in the viewing interface based on a selection of a target user for a target interaction item associated with the current user, the interaction component presenting identification information of the target user and first content generated based on the target interaction item.

2. The method of claim 1, wherein presenting the viewing interface of the information stream associated with the current user comprises:
receiving an interaction message associated with the target interaction item, the interaction message being sent in response to the selection of the target user for the target interaction item; and
in response to a first predetermined operation for the interaction message, presenting the viewing interface of the information stream associated with the current user.

3. The method of claim 1, wherein the interaction component is associated with a first content set, and the method further comprises:
switching the interaction component to presenting second content in the first content set in response to a second predetermined operation for the interaction component.

4. The method of claim 3, wherein presenting the interaction component in the viewing interface comprises:
presenting, in the viewing interface, the interaction component in a target style determined based on a number of pieces of content to be presented in the first content set.

5. The method of claim 4, wherein the target style indicates that a plurality of component elements in the interaction component are presented in a stack in response to the number of pieces of content to be presented being greater than a target threshold.

6. The method of claim 3, wherein the interaction component is a first interaction component, and the method further comprises:
providing a filtering control in the viewing interface; and
presenting a second interaction component in the viewing interface based on a target condition, the target condition being determined based on the filtering control and the second interaction component being associated with a second content set that matches the target condition.

7. The method of claim 1, further comprising:
in response to a third predetermined operation received in the viewing interface, sending, in a session between the current user and the target user, a message determined based on the third predetermined operation to the target user.

8. The method of claim 7, wherein the third predetermined operation comprises at least one of the following:
a sliding operation for the interaction component,
a selection of an indication element in the viewing interface, the indication element corresponding to predetermined feedback for the first content, or
a selection of a message portal for the viewing interface.

9. The method of claim 1, further comprising:
in response to a fourth predetermined operation received in the viewing interface, providing an adding portal in the interaction component, wherein the adding portal is configured to trigger an adjustment of an interaction relationship between the current user and the target user.

10. The method of claim 1, further comprising:
receiving a selection of the current user for a second user; and
in response to a predetermined condition associated with the second user being satisfied, triggering a client associated with the second user to present at least one interaction item associated with the current user to the second user.

11. The method of claim 1, further comprising:
switching the viewing interface to presenting media content in the information stream in response to a fifth predetermined operation received in the viewing interface.

12. An electronic device, comprising:
at least one processing unit; and
at least one memory, coupled to the at least one processing unit and storing instructions for execution by the at least one processing unit, the instructions, when executed by the at least one processing unit, causing the electronic device to perform operations comprising:
presenting a viewing interface of an information stream associated with a current user; and
presenting an interaction component in the viewing interface based on a selection of a target user for a target interaction item associated with the current user, the interaction component presenting identification information of the target user and first content generated based on the target interaction item.

13. The electronic device of claim 12, wherein presenting the viewing interface of the information stream associated with the current user comprises:
receiving an interaction message associated with the target interaction item, the interaction message being sent in response to the selection of the target user for the target interaction item; and
in response to a first predetermined operation for the interaction message, presenting the viewing interface of the information stream associated with the current user.

14. The electronic device of claim 12, wherein the interaction component is associated with a first content set, and the operations further comprise:
switching the interaction component to presenting second content in the first content set in response to a second predetermined operation for the interaction component.

15. The electronic device of claim 14, wherein presenting the interaction component in the viewing interface comprises:
presenting, in the viewing interface, the interaction component in a target style determined based on a number of pieces of content to be presented in the first content set.

16. The electronic device of claim 15, wherein the target style indicates that a plurality of component elements in the interaction component are presented in a stack in response to the number of pieces of content to be presented being greater than a target threshold.

17. The electronic device of claim 14, wherein the interaction component is a first interaction component, and the operations further comprise:
providing a filtering control in the viewing interface; and
presenting a second interaction component in the viewing interface based on a target condition, the target condition being determined based on the filtering control and the second interaction component being associated with a second content set that matches the target condition.

18. The electronic device of claim 12, wherein the operations further comprise:
in response to a third predetermined operation received in the viewing interface, sending, in a session between the current user and the target user, a message determined based on the third predetermined operation to the target user.

19. The electronic device of claim 18, wherein the third predetermined operation comprises at least one of the following:
a sliding operation for the interaction component,
a selection of an indication element in the viewing interface, the indication element corresponding to predetermined feedback for the first content, or
a selection of a message portal for the viewing interface.

20. A non-transitory computer-readable storage medium, having a computer program stored thereon, the computer program being executable by a processor to implement a method comprising:
presenting a viewing interface of an information stream associated with a current user; and
presenting an interaction component in the viewing interface based on a selection of a target user for a target interaction item associated with the current user, the interaction component presenting identification information of the target user and first content generated based on the target interaction item.
